(19) United States
(12) Patent Application Publication
(10) Pub. No.: US 2008/0189170 A1
(43) Pub. Date: Aug. 7, 2008

(54) SENSOR NETWORK-BASED CONTEXT-AWARE CONTENT DELIVERY SYSTEM

(75) Inventor: Girish A. Ramachandra, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/024,003

(22) Filed: Jan. 31, 2008

(30) Foreign Application Priority Data
Feb. 1, 2007 (IN) 237/CHE/2007

(51) Int. Cl. G06Q 10/00

(52) U.S. Cl. 705/10

(57) ABSTRACT

A dynamic and extensible architecture allows the selection and delivery of content in light of current context, including shopper in-store location information. Both static and real-time operation are supported. Business events can be generated based on information derived from sensors, from other business events, or both. A rich context supporting a wide variety of conditions can be supported, including shopper in-store location, shopper history, shopper in-store shopping path, and the like. Content can be delivered in a personalized, shopper-specific manner, according to any condition indicated in the current context. Content directed to store operational staff, such as out-of-stock notifications, can also be supported. New devices or applications can easily be added to the system. Context relevant content can be delivered via a variety of mechanisms, including the shopper's own cell phone to enable a cost effective delivery channel.

### BACKGROUND

Retailers and consumer packaged goods firms spend an enormous amount of money in efforts to drive customer traffic into stores. Meanwhile, it has been observed that 70% of buying decisions are made in-store during the act of shopping. So, even if the effort to get the shopper into the store is successful, it is not clear that any meaningful impact is made unless a message is delivered to the customer in the store. Unfortunately, by the time the shopper's identity is determined at the checkout counter, it may be too late for any useful interaction to influence the shopper's behavior in the purchasing process.

Although a wide variety of analytical tools for market basket analysis, item affinity analysis, customer segmentation, and the like can help marketing efforts, they can be limited in their effectiveness by their static and generic nature.

There thus remains room for improvement in delivering content to shoppers.

### SUMMARY

A system architecture can support delivery of a wide variety of content in light of current shopper context. The context can include such conditions as a shopper's current in-store location information.

A rich context supporting a wide variety of conditions can be supported, including shopper in-store location, shopper history (e.g., shopper purchases in current shopping trip, a past shopping trip, or both), shopper in-store shopping path, and the like.

Shopping business events can be generated based on information derived from sensors, from other shopping business events, or both.

Both static and real-time operation can be supported.

Content can be delivered in a personalized, shopper-specific manner, according to any condition indicated in the current context.

Content directed to non-shoppers, such as out-of-stock notifications can also be supported on the same network.

New devices or applications can easily be added to the system.

Content can be delivered via a variety of mechanisms, including cell phone delivery and leveraging of existing hardware such as store mobile solutions such as PDAs and Tablet PCs.

The system can employ a network of sensors and applications (e.g., including sensor-based applications) in a retail sales floor to sense physical world events to make real-time decisions on the choice of content, choice of delivery media, and the timing of delivery. Real-time decisions can be based on real-time analytics.

Activities of the system can be logged for off-line analytics, by which the true value of the content delivery can be determined.

Point of purchase interventions (e.g., in-store marketing, advertisements, offers, promotions, and the like) can be made more effective when delivered with a contextual relevance to the shopper via systems described herein.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system configured to implement sensor network-based context-aware content delivery.

FIG. 2 is a flowchart of an exemplary method of providing sensor network-based context-aware content delivery.

FIG. 3 is a block diagram of an exemplary system supporting multiple applications that can be shopper context-aware.

FIG. 4 is a flowchart of an exemplary method of generating shopper context-aware content.

FIG. 5 is a block diagram of an exemplary shopper context.

FIGS. 6A-D are block diagrams of exemplary shopping business events.

FIG. 7 is a block diagram of an exemplary store layout of a sensor network.

FIG. 8 is a block diagram of an exemplary application node configured to generate a shopping business event.

FIG. 9 is a block diagram of an exemplary application node configured to reference a database.

FIG. 10 is a block diagram of an exemplary application node configured to generate a location-type shopping business event.

FIG. 11 is a flowchart of an exemplary method of processing idle shopping business events by an application node.

FIG. 12 is a flowchart of an exemplary method of processing sensor data by an application node to generate an out-of-stock business event.

FIG. 13 is an illustration of exemplary content delivery to a cell phone.

FIG. 14 is an illustration of exemplary content delivery to a cell phone.

FIG. 15 is an illustration of an exemplary implementation of shopper context awareness in a store.

FIG. 16 is a block diagram of an exemplary computing environment for implementing a sensor network-based context-aware content delivery system.

### DETAILED DESCRIPTION

### Example 1

### Exemplary System Overview

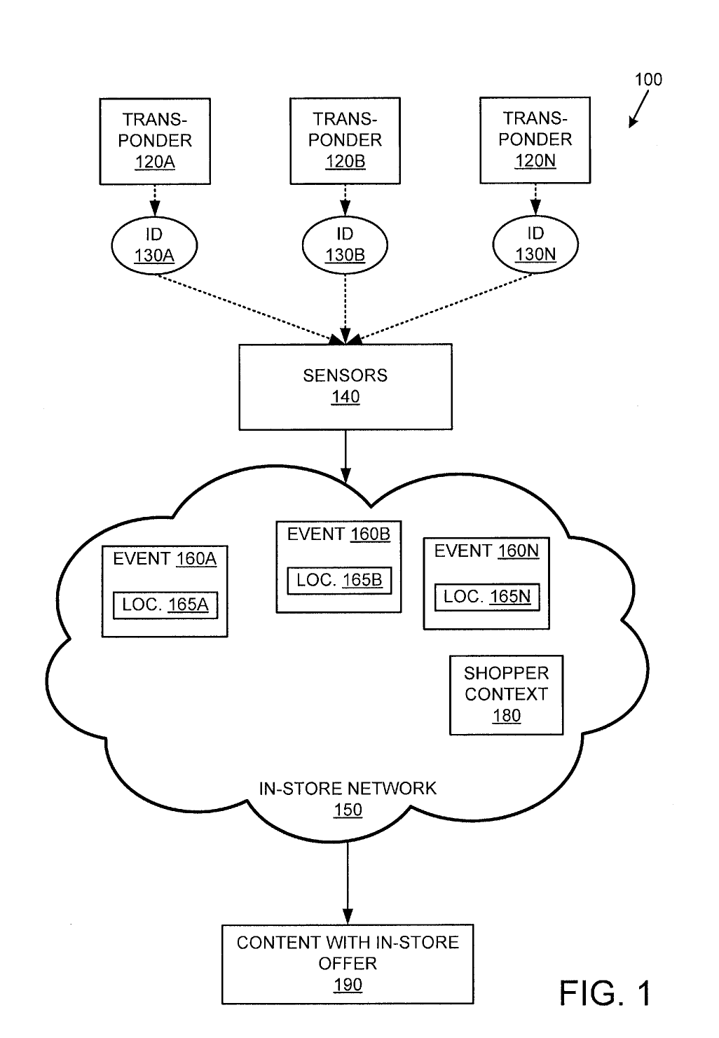

FIG. 1 is a block diagram of an exemplary system 100 configured to implement sensor network-based context-aware content delivery. The system 100 and variants of it can be used to implement any of the methods described herein.

In the system 100, a plurality of transponders 120A-N provide respective transponder identifiers 130A-N to an array of a plurality of in-store sensors 140. The transponders can be located on shopping carts on a retail sales floor, for example.

Based on data provided by the sensors 140, an in-store network 150 generates a plurality of location events 160A-N that can be used to construct a shopper context 180. Based on the shopper context, content 190 comprising an in-store offer can be generated. The content 190 can then be delivered to a shopper while shopping (e.g., during the same shopping trip that the sensors 140 detected movement of the shopper).

### Example 2

### Exemplary Method

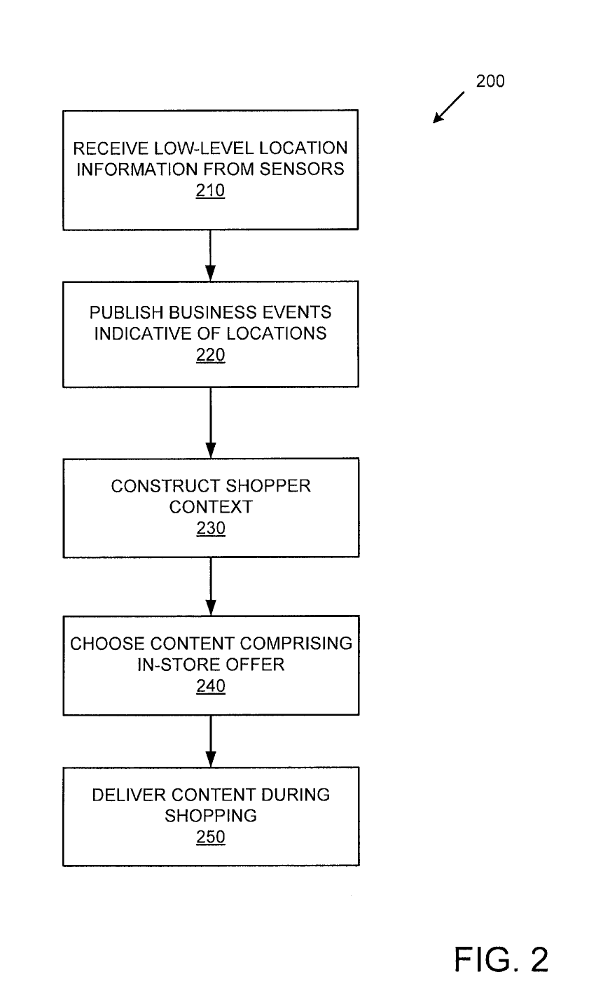

FIG. 2 is a flowchart of an exemplary method 200 of providing sensor network-based context-aware content delivery. Any of the methods described herein can be implemented by computer-executable instructions in one or more computer-readable media causing a computer to perform the described method.

At 210, low-level location information is received from sensors within the store. For example, transponders placed on shopping carts can be detected (e.g., along with low-level location information such as an identifier), and their location determined by in-store sensors. The transponders can be operable to participate in a wireless mesh network established in the store and transponder locations can be detected through interactions with the in-store sensors. The low-level location information can be translated, filtered, and quality controlled to result in more high level location information, such as an indication that a shopping cart (e.g., and thus the shopper) has moved to one of a number of locations in the store (e.g., an aisle within a product category).

At 220, based on the low-level location information, a shopping business event indicative of the location of the shopper is published on the network.

At 230, a shopper context is constructed, based at least on a location of the shopper. The context can include any of the other conditions described herein, such as a shopping history for the shopper.

At 240, content comprising an in-store offer is chosen based at least on the shopper context.

At 250, the content is delivered to the shopper during shopping. Content can be delivered to a variety of devices, including devices maintained by the store, devices brought by the customer into the store, or both.

### Example 3

### Exemplary Transponders

In any of the examples herein, a transponder can be any device that transmits a predetermined message. Such a transponder can transmit the predetermined message in response to reception of a signal such as an interrogation signal. The predetermined message typically includes a transponder identification number that identifies the transponder.

Exemplary transponders include RFID tags, other radio-frequency emitting devices, or other automatic identification technology.

Transponders can be fixed to a shopper locator device (e.g., a shopping cart). Such transponders can transmit signals that can be used to determine a shopper location, shopper locator device location, a path of a shopping cart through a store, or to otherwise track movement of a shopper.

Transponders can also be fixed to or placed on shelves, displays, kiosks, cart mounted displays, or products. Such transponders can transmit signals that can be used to provide information on product movement and shopper activities or to monitor stock, for example.

Transponders can be active or passive and can be configured to sleep (e.g., to conserve energy) or not to sleep. Transponders can be configured to participate in an in-store network, to interact with sensors, and to interact with other transponders.

### Example 4

### Exemplary Sensors

In any of the examples herein, a sensor can be a device that can sense a physical or environmental condition, such as temperature, sound, electromagnetic waves, vibration, pressure, motion, or pollutants at a sensor location or in proximity of the sensor. In general, sensors can monitor an environmental variable and may be capable of passing information from one sensor or node to the next.

Exemplary sensors can sense signals transmitted from transponders. For example, a sensor can be an RF signal sensor or reader that receives RF signals such as the signals transmitted by an RFID tag.

Sensors can be distributed through a store and the sensors can have an identifier which can be associated with an in-store location. The sensors can be part of an in-store network or form a sensor network. Sensors can communicate via the network or with another network via wires or wirelessly.

In practice, sensors can detect location information of a shopper by detecting one or more identifiers transmitted by one or more transponders. For example, given an identifier of a sensor (e.g., which is associated with an in-store location) and an identifier of a transponder (e.g., which is associated with a shopping cart), the location of a shopping cart, and thus the shopper location can be determined.

Sensors can also detect product movement by detecting transponders fixed to a product on a shelf, or by detecting product presence or absence on a shelf.

In some examples, sensors can detect an identifier transmitted by a transponder fixed to a product. In these examples, it can be determined whether a particular product has been moved or placed in a shopping cart.

Sensors can be connected to nodes or to transponders. For example, a smart sensor can be an application node configured to include a sensor.

Sensors can be configured to be always on or to sleep (e.g., to reduce power consumption). They can be active or passive devices.

### Example 5

### Exemplary Shopper Locator Device

In any of the examples herein, a shopper locator device can be a variety of devices that can accompany a shopper on a shopping trip. For example, such items can be carried or pushed by a shopper. Exemplary shopper locator devices include shopping carts, shopping baskets, a shopper ID card, or an anonymous shopper card. Shopper locator devices typically have a transponder attached or embedded in them so the transponder transmits information that can be used to determine a shopper locator device location which is associated with a shopper location.

### Example 6

### Exemplary Network

In any of the examples herein, a network can be a wired or wireless system for routing data or messages between nodes. The nodes in the network can be connected as a mesh network. The network can follow a publish/subscribe model. Communication between nodes can be based on any network protocols. For example, nodes can communicate via software and protocols based on the ZigBee specification, WiFi techniques, or the like.

### Example 7

### Exemplary In-Store Offers

In any of the examples herein, an in-store offer can be any information distributed to a shopper that is related to products in the store. Exemplary in-store offers include coupons, virtual coupons (e.g., redeemable at checkout), advertisements, incentives, promotions, product information, buying guides, rewards, discounts, and the like. In general, in-store offers are provided to a shopper to encourage a purchase, brand-switching, cross-selling, up-selling, and the like.

For example, a virtual coupon for a product, a buying guide providing favorable reviews of the product, and the like can be considered in-store offers that encourage a shopper to purchase the product and that promote the product. A coupon for a competing brand of a product can be considered an in-store offer that encourages a brand-switch, for example.

In-store offers can be delivered to a shopper according to content delivery methods described herein. In-store offers can be in the form of printed media or virtual media.

In-store offers can be chosen based on a shopper context, a business event, or both.

In-store offers can be automatically redeemed when the shopper purchases an item associated with the offer (e.g., at checkout, during self checkout, or the like).

### Example 8

### Exemplary Location Information

In any of the examples herein, a location of a shopper in a store can be associated with various levels of location information. For example, low level location information can include an identifier transmitted by a transponder or a sensor. Typically, low level location information is processed to determine higher level location information. The processing can be based on a physical location of a sensor or a transponder that is associated with a sensor ID or a transponder ID, respectively. Higher level location information can be, for example, coordinates within a store such as an aisle number, zone, endcap identifier, or store section. A predetermined set of locations can be defined and indicated by the system. Higher level location information can also be indicated by a proximity to products or displays.

The granularity of location information can be such that it is possible to determine that a shopper is in front of a particular product presentation. Thus, if it is detected that the shopper is idle in front of the display for a threshold time, content (e.g., an in-store offer) specific to the product in the display can be delivered to the shopper.

It is possible to maintain a plurality of locations for a single shopper (e.g., a fine grained location such as a particular display, medium grained location such as a store section, and the like).

### Example 9

### Exemplary Inter-Application Communication via Events

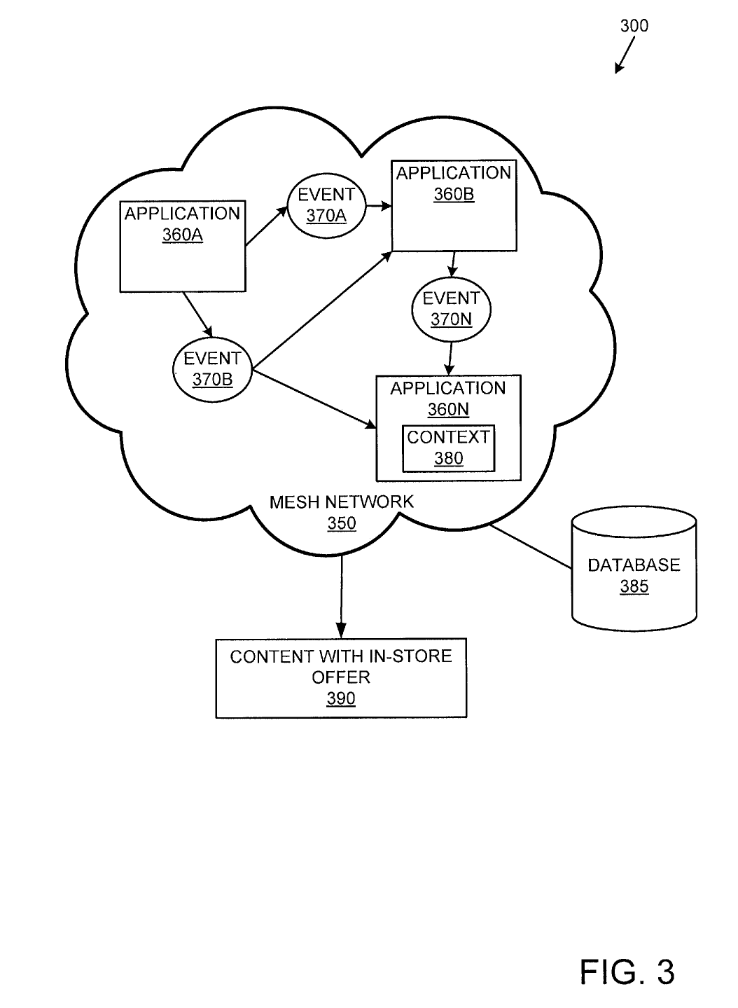

FIG. 3 is a block diagram of an exemplary system 300 supporting multiple applications that can be shopper context-aware.

In the example, a mesh network 350 can support a plurality of applications 360A-N and shopper business events 370A-N. An application can be included in any node as described herein.

A shopper context 380 can be maintained by an application 360N, or a separate mechanism (e.g., a context server) can be used.

A database 385 can be used to retrieve additional information, retrieve stored data, perform lookups, and the like. The components of the system need not all be local. A gateway (not shown) can be used to communicate with outside components (e.g., the Internet, other stores, corporate headquarters, vendor computer, and the like).

The content with an in-store offer 390 can be generated by the network 350 and subsequently delivered to the shopper.

### Example 10

### Exemplary Method of Context-Aware Content Delivery

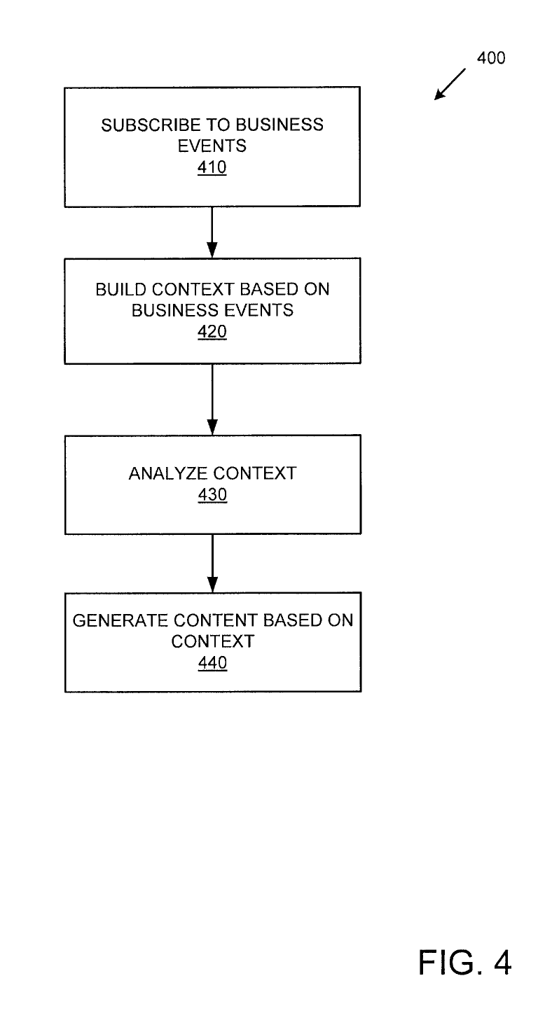

FIG. 4 is a flowchart of an exemplary method 400 of generating shopper context-aware content. At 410, shopping business events are subscribed to (e.g., by an application on the network). At 420, a shopper context is built based on shopping business events. For example, the shopping business events can be based on low-level location information.

At 430, the context is analyzed. At 440, based on the analysis of the shopper context, content comprising an in-store offer is generated.

### Example 11

### Exemplary Shopper Context

In any of the examples herein, a shopper context can comprise any of a variety of conditions that describe a shopper and one or more shopping trips. Thus, a rich context can be supported. A shopper context is useful for determining what content to generate for an in-store offer. The context can be stored in computer-readable media for later analysis and retrieval. For example, a shopper context can be stored in one or more nodes or in a database such that it can be referenced and accessed by nodes.

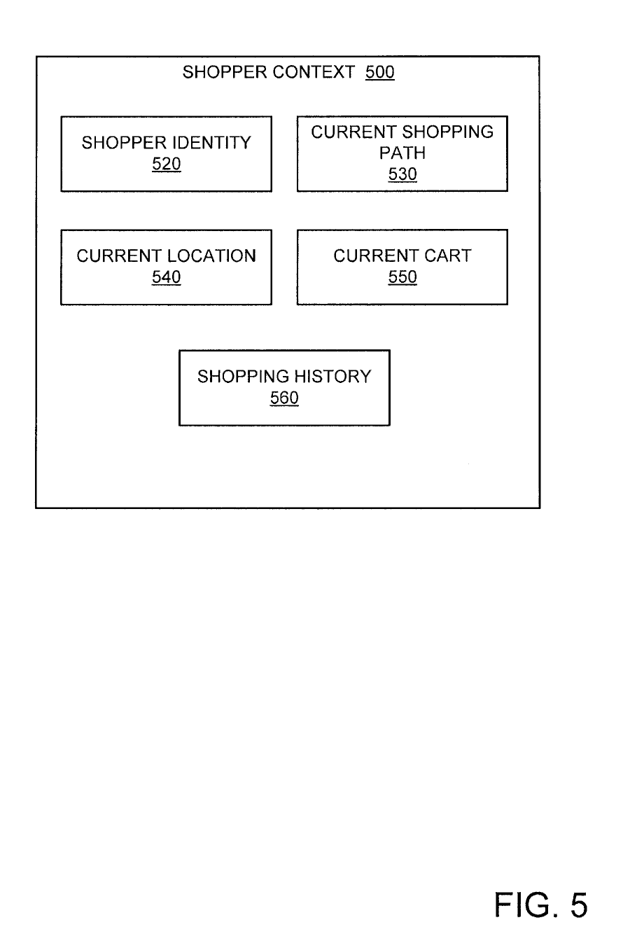

FIG. 5 is a block diagram of an exemplary shopper context 500.

The shopper context 500 can comprise a shopper identity 520. The shopper identity can be anonymous and include an anonymous shopper identifier such as an assigned identification number or an ID for a shopper locator device. The shopper identity can include a shopper identifier such as a shopper ID number, shopper account number, or loyalty card account. A shopper identity can include shopper specific information associated with a shopper identifier. Such information can include income, number of individuals in a household, home address, shopper preferences, product preferences, shopping list, wish list, other information input by the shopper, or information specific to the shopper.

The shopper context 500 can comprise a current shopping path 530. For example, the current shopping path can be the route that a shopping cart has traced through a store on the current shopping trip. The current shopping path can be a list of locations in the store where a shopping cart has been. These locations can be associated with a time, timeframe, date, and the like.

The shopper context 500 can comprise a current location 540. For example, a current location can be a current physical location of a shopping cart and be indicated by high or low level location information. The current location can include a timeframe such as the idle time spent by a shopper at the location.

The shopper context 500 can comprise a current shopper locator device (e.g., cart) 550. For example, the current shopper locator device identifier can include an identifier for the cart a shopper is currently using during a shopping trip. The identifier can be the identifier for a transponder on the cart.

The shopper context 500 can comprise a shopping history 560, which can be a shopping history as described herein.

Because shopper context can include current location and shopping history, it is sometimes called a “real-time shopper context.” Shopper context therefore provides visibility of the shopping process as it occurs and enables content to be chosen in real time based on shopper activities and shopper locations. Such content can be referred to as “context relevant content” or as “context-aware content.”

As stated above, a shopper context can be built for an anonymous shopper. For example, if a shopper does not log-in to the in-store network but uses a shopper locator device while shopping, the shopper context can be generated based on an identifier of the shopper locator device or based on an anonymous identifier that the network assigns to the shopper. In some examples, a shopper can log-in to the network and choose to be anonymous (e.g., sign in as a guest).

### Example 12

### Exemplary Context Analysis

Awareness of shopper context and shopper activities enables focused and relevant interventions that are context-aware.

For a circumstance where a new brand would like to incentivize brand switching from an incumbent, the new brand can benefit from context-awareness through the ability to advertise promotional offers to shoppers while they are in the act of shopping. In this example, the act of a shopper shopping the competing brand is sensed by systems described herein to develop context-awareness. Responsive to the context-awareness (i.e., that the shopper is shopping the competing brand), a promotion for the new brand can be presented to the shopper. By providing awareness of the shopper context, the system enables the new brand to present a promotion at a moment when the shopper's decision can be influenced.

In another situation, context-awareness can include awareness of the context of several shoppers. For example, the concentration of shoppers in various sections of a sales floor and at certain times can be sensed by systems described herein. Based on this type of multiple shopper context-awareness, labor and work scheduling decisions can be made. For example, more employees can be deployed to open additional checkout lanes when shopper concentrations indicate long lines are forming at the checkout. By providing context-awareness, the system enables a retailer to react to real-time situations in a way that can improve store efficiency.

### Example 13

### Exemplary Shopping History

In any of the examples herein, a shopping history can be a same-trip shopping history, a history of one or more past shopping trips, or a combination thereof.

A same-trip shopping history can include information such as locations in the store that the shopper has already visited, products already purchased, products placed in the cart, or the like. For example, the same-trip shopping history can retain a list of products purchased through a perpetual self checkout.

A past shopping trip shopping history can include information such as products purchased on past trips, dates and times of past shopping trips, past shopping cart routes, or the like. A shopping history can also include content already delivered to the shopper (e.g., during the same shopping trip or during a past shopping trip) and shopper responses to the delivered content.

A same-trip shopping history can be acquired even if the shopper is anonymous (e.g., the history can be associated with an assigned identifier or a shopper locator device ID). History of past shopping trips is typically accessed via a shopper identifier.

Any shopping history can be used to determine what a shopper is likely to buy next, suggest a brand switch, or the like. For example, any shopping history can be used to determine content to be delivered to a shopper.

Shopping history can also be used to prompt stock replenishment (e.g., when it is detected that a shopper buys or is likely to buy a product every n days or a product has been added to a shopper wish list).

In practice, a shopper history can be provided as a link to the data from which an application can retrieve the information desired to make a decision regarding what content to generate.

### Example 14

### Exemplary Shopping Business Events

In any of the examples herein, shopping business events can be published for consumption by components of the network. The events can indicate any of a variety of conditions and subsequently can be used to build a shopper context as described herein, to chose or generate in-store offers as described herein, or to generate other business events.

The shopping business events can be of designated types (e.g., location, idle shopper, shopper purchase, stock, etc.) The shopping business event type can be included in the event (e.g., as a code or text) or otherwise indicated. Content can be indicated in a content-type shopping business event.

Shopping events can be published according to a shopping business event protocol. For example, a shopping business event protocol can be a set of rules that describe a syntax and content of a published message representing a shopping business event. Such a set of rules can determine how the conditions indicated by the shopping business event are represented in the message. For example, the message can include a type, a time, a date, a shopping ID, and other information specific to the event.

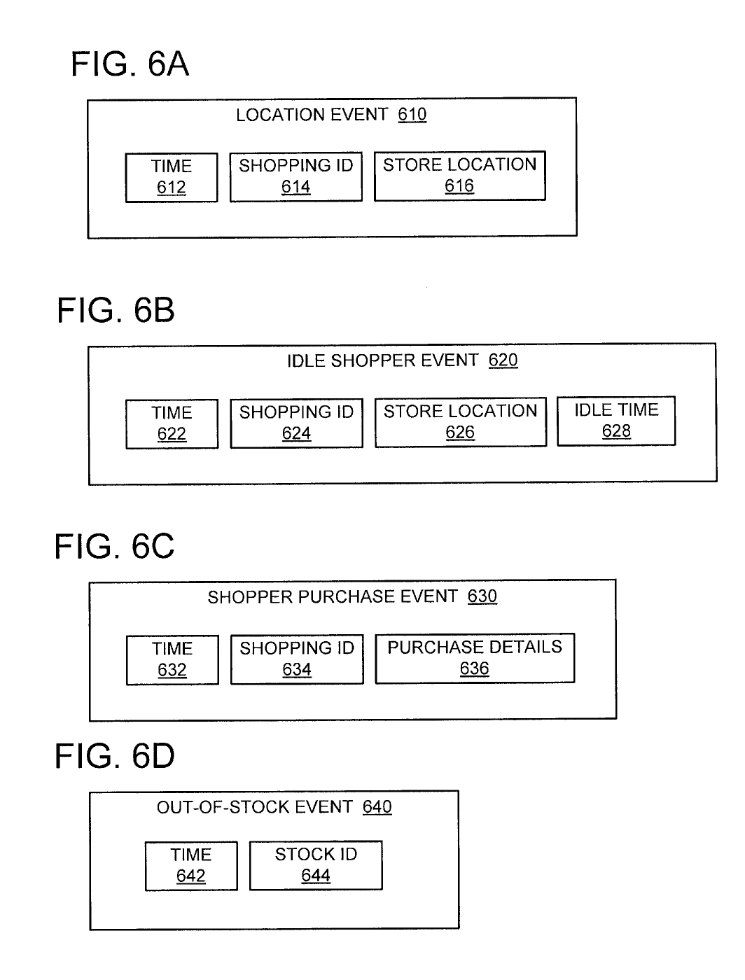

FIGS. 6A-D are block diagrams of exemplary shopping business events 610, 620, 630, 640. The shopping business events 610, 620, 630, 640 indicate times 612, 622, 632, 642, respectively, which can be a timestamp when the event was generated. The shopping business events 610, 620, 630 indicate shopping IDs 614, 624, 634, respectively. The shopping identifier can be indicative of a shopper (e.g., indicate a shopper or shopping cart). The shopper can be identified even if anonymous (e.g., via a unique shopper identifier or a shopping cart ID, even if the identity of the shopper is not known).

The shopping business events 610, 620 indicate store locations 616, 626, respectively, which can be a current location of a shopper, for example. Idle shopper event 620 indicates an idle time 628, which can indicate a time spent by a shopper at the store location 626. Shopper purchase event 630 indicates purchase details 636, which can indicate products purchased by shopper having shopping ID 634. Out-of-Stock event 640 indicates a stock ID 644, which can include an ID for a product that is out-of-stock.

Although not shown, the events can also include a field indicating the type of event, or the event type can be implied based on content or source of the event.

Shopping business events can also describe conditions such as an in-store traffic count, a location-specific in-store offer, an abandoned cart, a shopper log-in, a shopping cart route, purchase of a high profit margin product, and the like. For example, an abandoned shopping cart business event can indicate that a shopping cart has been stationary for more than a pre-determined period of time. Such a business event can provide visibility to the opportunity cost of lost business.

In general, any type of shopper activity, shopper action, or shopper response can be indicated by a business event and business events can also indicate product movement. Shopping business events can be based on any conditions which can be sensed by exemplary sensors or sensor networks, provided from outside sources, or the like.

A shopping business event can also be a combination of other shopping business events. For example, purchase business events and a shopping cart route event can be combined to indicate purchases made after shopping a particular in-store route.

### Example 15

### Exemplary Shopper Activities

In any of the examples herein, a shopper activity can be an action associated with a shopper. During a typical shopping trip, a shopper can perform various actions that can be relevant to context-aware content delivery and thus processed as exemplary shopper activities.

For example, a shopper activity can be a product choice that can be based on shopper actions such as purchasing a product, examining the product, picking the product up, placing the product in a shopping cart, and the like. Other exemplary shopper activities can be related to shopper movement throughout the store (e.g., activities indicated by location type business events) or shopper initiated accessing of the network (e.g., by logging-in to the network or requesting information).

Shopper activities can be indicated by exemplary business events. Different types of events can represent different activities. The event can include parameters indicating the shopper activity.

A shopper activity can also include shopper responses such as a shopper action that is in response to content delivery (e.g., the action occurs after content is delivered). For example, a decision to purchase a product (or not to purchase the product) after a virtual coupon is delivered to the shopper can be considered as part of a shopper response to the coupon.

### Example 16

### Exemplary Association between a Shopper Locator Device and a Shopper

In any of the examples herein, an association between a shopper locator device (e.g., a transponder or a device comprising a transponder) and a shopper can be maintained. An association between a shopper locator device and a shopper is typically between a shopper identifier and a shopper locator device identifier. A shopper locator device identifier can be an ID for a transponder fixed to a shopper locator device or an ID assigned to the shopper locator device (e.g., a shopping cart ID number).

An association between a shopper locator device and a shopper can be created in various ways. For example, a shopper can log in to an in-store network such as by inputting a shopper identifier (e.g., a shopper ID number or a shopping cart ID) or by tapping or swiping an ID card or loyalty card. In other examples, a shopper can sign in to an application on a cell phone and enter an identifier of a shopping cart (or other shopper locator device) to be used on a specific shopping trip. In some examples, the cell phone is a near-field communication (NFC) phone and a shopper NFC phone can create an association between the shopper and a shopping cart when an RF tag on the shopping cart is automatically scanned by the NFC phone.

Such shopper activities can generate a log-in business event. The log-in business event can include an association between a shopper locator device ID and an identifier for the shopper that logged in.

The association can be stored (e.g., in a look up table) in a database and can be accessible by applications, nodes, or other elements of the network. For example, a database can receive a query specifying a shopper locator device ID and respond with a shopper identifier or name. The association can also be stored as part of a shopper context.

### Example 17

### Exemplary Integration with Out-of-Stock Events

In an exemplary integration with out-of-stock events, out-of-stock type events can be generated by an in-store network described herein. The events can be received by a gateway. A gateway can map the out-of-stock events to a response and the response can be executed. For example, the gateway can receive an out-of-stock event indicating a product in the produce section is out of stock or low stock and generate a text message to be sent to a stocker of the produce section.

In some examples, out-of-stock events are generated by a product display unit (e.g., comprising one or more shelving units) that can detect product availability using RFID readers and RFID tags. Such product display units can be capable of detecting product availability even when products do not have RFID tags. Such product display units can also be operable as a node (e.g., an application or sensor node) and as part of an in-store network or a sensor network. An example of an exemplary product display unit that can detect product availability is described in Ramachandra, U.S. patent application Ser. No. 12/023,682, “RFID Based Product Level Availability” filed Jan. 31, 2008, which is herein incorporated by reference.

### Example 18

### Exemplary Integration with Real-Time Analytics

In an exemplary integration with real-time analytics, business events and shopper contexts can be processed according to real-time analytics. For example, real-time analytics can include analytical tools such as those for market basket analysis, item affinity analysis, customer segmentation, correlation, and the like. Real-time analytics can be any type of information or data mining.

In some examples, real-time analytics are used to evaluate the effectiveness of an in-store offer or of a content delivery. For example, a correlation between in-store delivered content and a result of the content delivery (e.g., shopper response) can be generated. For example, the result can indicate whether a shopper bought a product targeted by the content after the content was delivered to the shopper. One or more business events, one or more shopper contexts, or both can also be correlated with the result and evaluated.

In an example scenario, a promotion of a competing brand of breakfast cereal is displayed to a shopper at the time of choosing a cereal to buy in order to influence a brand switch. An in-store sensor network as described herein can track such events and real-time analytics can provide a measure of the effectiveness of the displayed promotion based on the timing of the promotion display, the location of the shopper, and other shopper context.

In other examples, real-time analytics can be used to gather and evaluate information about a group of shoppers such as by evaluating a large number of shopper contexts. For example, information on shopper paths and shopper purchases (e.g., from shopper histories) can be analyzed to develop insights into item affinities which could be potentially used for micro-merchandising and space planning decisions.

In some examples, real-time analytics can be integrated with stock events to determine the impact of a stock event. For example, out-of-stock events and shopper contexts can be analyzed to measure the opportunity cost of a stock out by comparing footfalls to the shelf, and the sales uplift of competing products in the same category during the stock out period.

Real-time analytics can be used to assess the timing and profitability of content delivery and can be useful for business decisions concerning pricing, promotions, product placement, planograms, merchandising, business model evaluation, and the like. Real-time analytics can be in real-time or delayed from real-time events, such as offline, or real-time analytics can be combined with offline analytics.

Real-time analytics can also be used as a basis for content monetization. For example, a price can be assigned to a content delivery based on an effectiveness of the content delivery. For example, a content delivery such as an advertisement that results in an actual or real-time sale (or any other event of business value) could be priced at a premium and charged to a retailer or a product manufacturer (e.g., a CPG company).

Real-time analytics can be performed by a server, a gateway, an enterprise, or a remote system where business events and shopper context can be aggregated. Real-time analytics can also be performed by applications such as those included in application nodes. Real-time analytics can also be used to generate business events.

### Example 19

### Exemplary In-Store Network

In any of the examples herein, an in-store network can take the form of a network of nodes in a store wherein at least a portion of the nodes are application nodes that communicate with sensor nodes, sensors, or a sensor network. In general, an in-store network can include any number and combination of the nodes described herein.

Communication between nodes can be based on any network protocols. For example, nodes can communicate via software and protocols based on the ZigBee specification, WiFi techniques, or the like. Nodes in an in-store network can be organized into various topologies such as a mesh network topology.

### Example 20

### Exemplary Nodes

In any of the examples herein, a node can be a wired or wireless electronic device in a network. A node can be configured to receive data, transmit data, or both. For example, a node can include transmitters, receivers, readers, an antenna, and the like. Nodes can be a computing device such as a computer, laptop, or other processor or a node can be a portable computing device such as a PDA, cell phone, a smart shopping assistant, or a shopping cart mounted display.

Nodes can be individually configured to have different functions. For example, nodes can include software instructions which determine node functionality. Nodes can be configured to make decisions regarding whether to transmit/relay messages. Nodes can be configured according to a publish/subscribe model.

A harbinger node can be a node that relays and forwards messages (e.g., uniformly re-transmits received messages) and can be associated with product categories based on a harbinger node location.

A gateway node can refer to a node that aggregates business events and shopper contexts and can be configured to process business events or to forward them to an enterprise or out of network system.

An application node can refer to a node that includes an application, and a sensor node can refer to a node that includes a sensor. One or more nodes can be combined into nodes with increased functionality.

### Example 21

### Exemplary Sensor Nodes

In any of the examples herein, a sensor node is a node that comprises a sensor. A plurality of sensor nodes can form a sensor network, or one or more sensor nodes can be part of or communicate with an in-store network. The sensor nodes can communicate with other nodes via wires or wirelessly.

A sensor node can be a smart sensor such as a sensor that has on-board logic or software instructions, or a sensor node can be a lightweight node that does not perform any function other than sensing transponders or environmental conditions. In some examples, a sensor node is an NFC device such as an NFC phone.

### Example 22

### Exemplary Application Nodes

In any of the examples herein, an application node is a node that includes an application. In general, an application includes software instructions that at least partially determine a functionality of the node. For example, an application node can include instructions for processing sensor data using sensor based applications, or an application node can include an event engine for generating shopping business events (e.g., based on sensor data, other shopping business events, or shopper context).

Application nodes can subscribe to shopping business events and process shopping business events, data from sensors, stored data, and the like. Application nodes can also generate and publish business events. An application node can build a shopper context or rely on a context built by another node. An application node can store or host shopping business events, shopper context, or both.

Application nodes can include on-board sensors or be combined with sensor nodes.

Due to the architecture of the system described herein, application nodes can be added or removed from the in-store network easily. For example, a vendor may wish to add a display or vending machine that includes an application node. Such a node can subscribe to or publish events and participate on the network. Security mechanisms can be implemented to prevent unauthorized access to the network and associated events.

If desired, a per-vendor security arrangement can be used to prevent one vendor from seeing events generated by another vendor.

### Example 23

### Exemplary Stock Monitoring Application Node

An exemplary stock monitoring application node is a node configured to communicate with an in-store network and to generate stock type events. For example, a stock monitoring application node can be configured to process sensor data indicative of stock of a particular product and to generate the stock type business events based on the processing. The stock type business events can then be published on the in-store network.

In some examples, a stock monitoring application node includes a sensor that detects products on a shelf and a sensor-based application that processes information received from the sensor and transmits stock type events based on the processing. The stock monitoring application node can generate an out-of-stock event when a product that is being monitored should be restocked. For example, an out-of-stock event can indicate that stock has been reduced to a threshold value (e.g., less than 50% stock). Other stock type business events can include stock updates (e.g., an indication of the amount of stock remaining on a shelf or that stock is full).

### Example 24

### Exemplary Cell Phone Application Node

A cell phone such as a shopper cell phone can be supported as a node in a sensor network-based context-aware content delivery system as described herein.

For example, a shopper cell phone can have one or more applications running or residing on the cell phone which can publish business events to an in-store network, receive content, or otherwise communicate with the network. The cell phone can be wirelessly paired (e.g., via Bluetooth) to electronic devices in the store and include applications configured to communicate with the in-store network via the electronic devices.

In some examples, the cell phone can include an application that is configured to enable perpetual self checkout. The cell phone can be wirelessly paired to a barcode scanner (e.g., via Bluetooth), for example, that is mounted on a shopping cart. When the shopper scans products with the barcode scanner, the application can generate a purchase business event or the application can maintain a list of products and generate a purchase business event when the shopper indicates that the trip is complete. In some examples, a cell phone application that enables perpetual self checkout can also enable a shopper to pay for the purchase via the cell phone.

In some examples, the cell phone includes an application that is configured to enable content to be delivered to the cell phone. For example, an application can enable in-store offers such as virtual coupons to be sent to the cell phone via the in-store network.

In other examples, the cell phone includes an application configured to allow a shopper to log-in to an in-store network. For example, the application can generate a log-in business event as a result of the shopper log-in. The application can be configured to allow the shopper to log-in to the network anonymously.

In some examples, the cell phone is an NFC phone that is configured to detect transponders in a store such as those located on shopper locator devices. For example, a shopper NFC phone can create an association between the shopper and a shopping cart when an RF tag on the shopping cart is scanned by the NFC phone. The NFC phone can also be configured to provide a shopper identifier to the in-store network.

In other examples, the cell phone includes an application that allows the shopper to submit a request to the in-store network. For example, the shopper can submit a request for product information or a request to access stored data. For example, the shopper can request to access a shopping list, a wish list, products purchased on past shopping trips, or a last date of purchase of a particular product.

A cell phone such as a shopper cell phone can also include applications that enable a shopper to input information when the phone is located outside of the store. For example, the shopper can download a shopping list to the cell phone or create the list using an application on the cell phone before entering the store. The shopper can be able access the shopping list while shopping. The shopping list can also become part of the shopper context such as when the shopper logs-on to the in-store network. The shopping list can also be a wish list. A shopping list or a wish list can then be used to provide insight into product demand and shopper intentions.

### Example 25

### Exemplary Sensor Network

In any of the examples herein, a sensor network is a wireless or wired network of sensors. A wireless sensor network (WSN) is a wireless network consisting of spatially distributed sensors to cooperatively monitor physical or environmental conditions. A sensor network can be combined with or in communication with other networks.

In a typical application, a WSN is scattered in a region where it is meant to collect data through the region for monitoring, detection, tracking, and surveillance purposes.

The sensor network can be configured as a mesh network and can be controlled/regulated using ZigBee or other network protocols. Sensors in a mesh sensor network can communicate among each other and relay messages within the network or to another network such as through network gateways.

### Example 26

### Exemplary Content

In any of the examples herein, exemplary content includes in-store offers, alerts, reports, shopping lists, wish lists, reminders, recipes, product location, shopper location, results from real-time analytics, results from offline analytics, and the like. Content can be in various forms such as printed media or virtual media.

Content can be chosen based on a shopper context, a business event, or both. Content that is chosen based at least on a shopper context can be referred to as “context relevant content.”

Content can be delivered according to delivery methods described herein. Content can be stored in a server, a database, a node, a gateway, or an enterprise system. Content can be mapped to events and the mapping can also include a delivery method. Mapping can be configured by an administrator or other user such as through a user interface.

### Example 27

### Exemplary Methods of Content Delivery

In any of the examples herein, content is delivered to a user through exemplary methods of content delivery. Exemplary methods of content delivery include a cell phone, NFC device, PDA, SMS messaging, Tablet PCs, text messaging, paging, intercom, dashboards, computer controlled user interfaces, in-store electronic display, in-store TV, in-store display or kiosk, cart mounted display, cell phone based application, coupon printer (e.g., located in a aisle), shopping assistant, other display, or other portable communications device.

Content can be delivered, for example, to a shopper, a store associate, a store employee/manager, or to an individual representing a particular packaged good or brand.

Content delivered to a shopper is typically delivered via an electronic device associated with the shopper. Because the shopper can be associated with a shopping cart that can be located within the store, it is possible to track the movement of the shopper and send content (e.g., in-store offers) directly to the shopper based on real-time analysis of the shopper's movement or other conditions in the shopper context for the shopper.

An electronic device can be associated with a shopper because of its proximity to the shopper. For example, a shopping cart mounted device such as a shopping assistant or a portable device such as a cell phone or a PDA are electronic devices that can be associated with a shopper. An in-store dynamic display or coupon printer that is nearby a current location of a shopper can be an electronic device associated with the shopper, for example.

Content that is delivered via a shopper cell phone can be enabled based on an application running on the cell phone or a cell phone number can be stored in a database as associated with a shopper identifier.

Content that is delivered via an in-store TV or dynamic display can be automated. For example, specific content can be assigned to channels of the TV and the channels can be changed automatically (i.e., by the sensor network-based context-aware content delivery system) according to shopper context.

### Example 28

### Exemplary Sensor Network

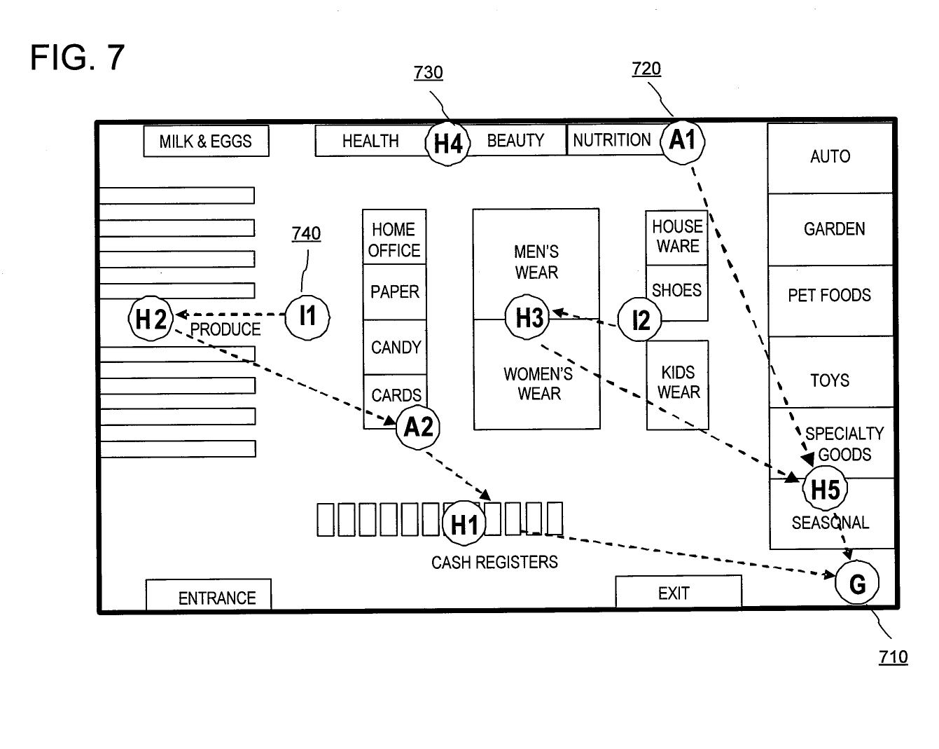

FIG. 7 is a block diagram of an exemplary store layout of a sensor network. The store layout indicates placement of various types of nodes within the store. A gateway node 710 can be a local server that aggregates and processes business events generated in the store before forwarding them on to an enterprise system(s). The store layout contains several harbinger nodes 730, labeled Hn. In the example, harbinger nodes are messenger nodes that are fixed in locations in the store and optionally associated with a product category. The harbinger nodes process and forward messages amongst other nodes in the network.

The store layout includes a number of application nodes 720, labeled An. In the example, the application nodes include sensors that can sense transponders. Application nodes also process business events and forward messages amongst other nodes in the network.

Identifier nodes 740 are fixed on shopping carts and baskets to track shopper activity on the sales floor. Identifier nodes include one or more transponders. These nodes broadcast pre-determined messages that are picked up by other nodes in the vicinity and processed further.

### Example 29

### Exemplary Application Node

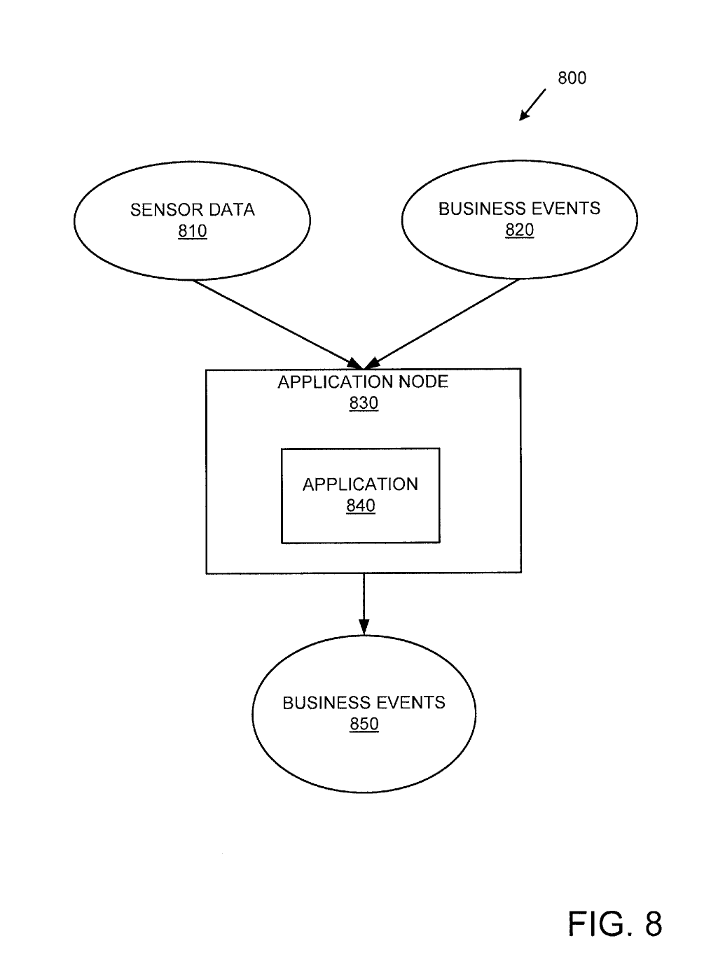

FIG. 8 is a block diagram of an exemplary system 800 implementing an application node 830. The system 800 and variants of it can be used in methods described herein.

In the example, the application node 830 is configured to receive sensor data 810 and business events 820 and to processes the received sensor data 810 and business events 820 to generate business events 850. The application node 830 can be configured to publish business events 850 to a network. The application node 830 can be configured to process the received sensor data 810 and business events 820 using an application 840. The application node 830 can subscribe to sensor data, business events, or both.

In practice, the system 800 can be more complicated, with additional inputs, outputs, and the like.

### Example 30

### Exemplary Application Node

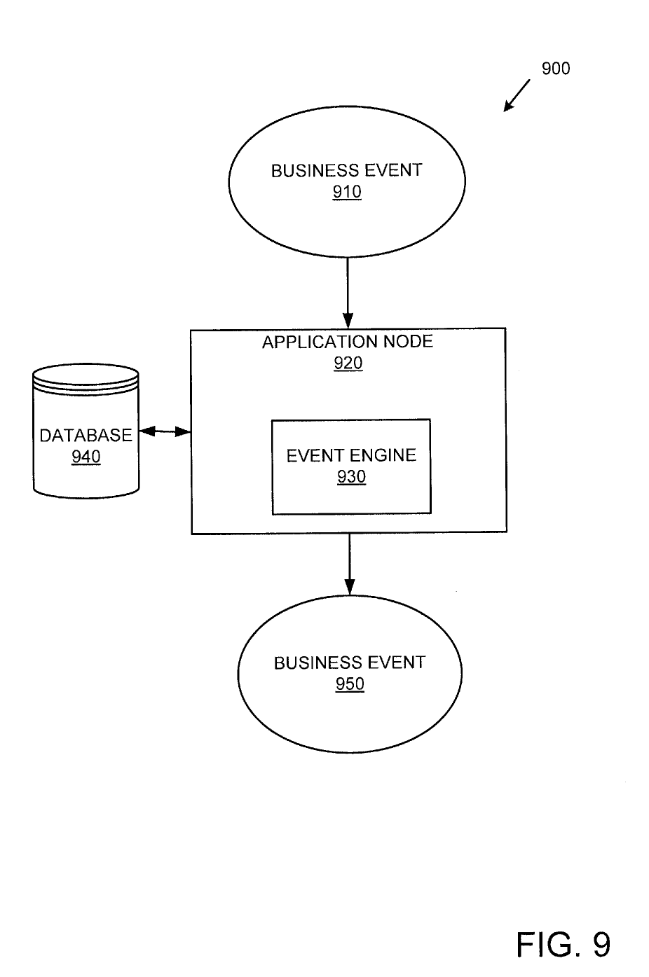

FIG. 9 is a block diagram of an exemplary system 900 implementing an application node 920. The system 900 and variants of it can be used in methods described herein.

In the example, application node 920 is configured to receive business events 910 and to generate business events 950. For example, application node 920 can generate a content-type event based on a received business event such as a location-type business event. The application node 920 can be configured to generate business events 950 based on data stored in database 940. The application node 920 can be configured to generate business events 950 using an event engine 930 included in the application node.

Business events 910 and business events 950 can be any of the exemplary business events described herein.

In practice, the system 900 can be more complicated, with additional inputs, outputs, and the like.

### Example 31

### Exemplary Application Node

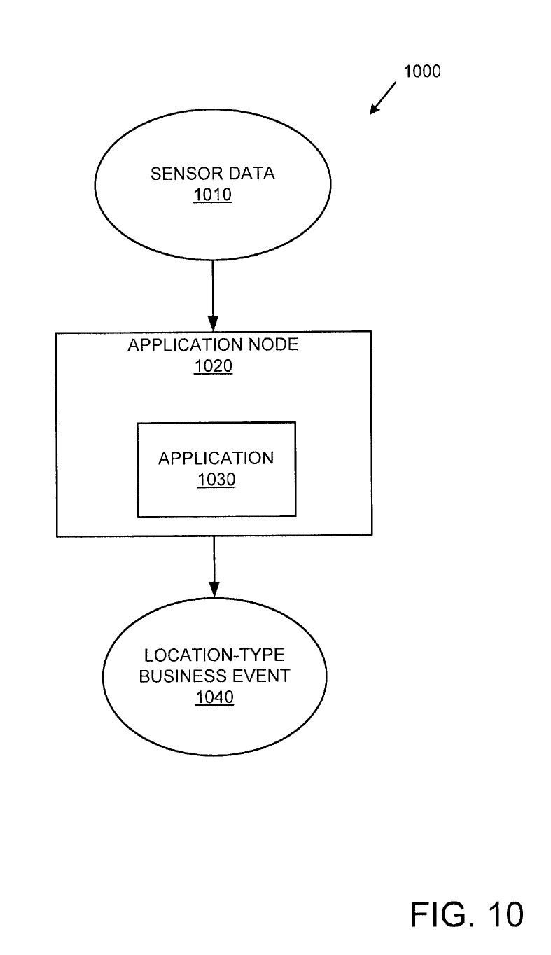

FIG. 10 is a block diagram of an exemplary system 1000 implementing an application node 1020. The system 1000 and variants of it can be used in methods described herein.

In the example, application node 1020 is configured to receive sensor data 1010 and to generate location-type business events 1040. The sensor data can be low-level location information. The application node 1020 can be configured to generate location-type business events 1040 based on an application 1030.

In practice, the system 1000 can be more complicated, with additional inputs, outputs, and the like.

### Example 32

### Exemplary Event Engine

In any of the examples herein, an event engine can used to process business events and shopper context and to generate business events. In general, an event engine can make decisions based on business events and shopper context. An event engine can reference a database during processing of business events and shopper context. Generation of business events can be based on mappings of content and events or on a set of rules provided by a retailer, consumer packaged goods company, brand representative, or other interested party.

### Example 33

### Exemplary Stored Data

In any of the examples herein, exemplary stored data can include results from real-time or offline analytics, shopping history, shopper context, business events, associations, location information, in-store offers, content, content mapping, and the like.

### Example 34

### Exemplary Processing of Idle Shopper Business Events

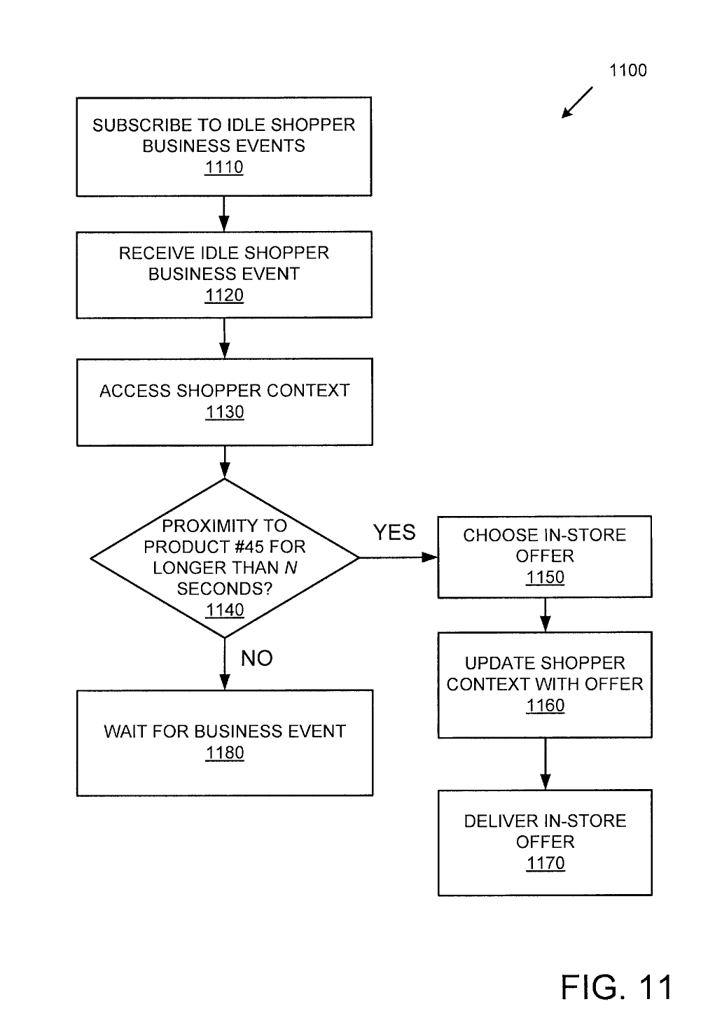

FIG. 11 is a flowchart of an exemplary method 1100 of processing idle shopping business events by an application node.

At 1110, idle shopper shopping business events are subscribed to by an application node. For example, the application node can be part of an in-store network.

At 1120, an idle shopper shopping business event is received by the application node.

At 1130, the application node accesses a shopper context. The shopper context can be stored at the application node or the shopper context can be accessed remotely by the application node, for example. The shopper context can be identified because it has the same shopper identifier as the shopping ID included in the idle shopper business event.

At 1140, it is determined whether the shopper has been in proximity of a particular product (e.g., product #45) for longer than a predetermined timeframe (e.g., n seconds).

At 1150, after it has been decided that the shopper has been in proximity of a product for longer than the predetermined timeframe, an in-store offer is chosen that is relevant to the product and based on the shopper context. For example, the in-store offer can be chosen to promote the product or to promote a competing product.

If the context indicates (e.g., via shopping history), that the shopper meets certain criteria (e.g., is a loyal customer of a brand), a personalized offer or other content can be extended.

At 1160, the shopper context is updated with the in-store offer. For example, the in-store offer can be included in the shopping history as content previously delivered to the shopper. The offer can also be registered with a point-of-sale system so that the offer (e.g., a virtual coupon) is automatically redeemed at checkout.

At 1170, the in-store offer is delivered to the shopper.

If at 1140 it is decided that the shopper has not been in proximity of a particular product for longer than a predetermined timeframe, at 1180, an application node can wait for other business events.

### Example 35

### Exemplary Processing of Sensor Data to Generate Out-of-Stock Event

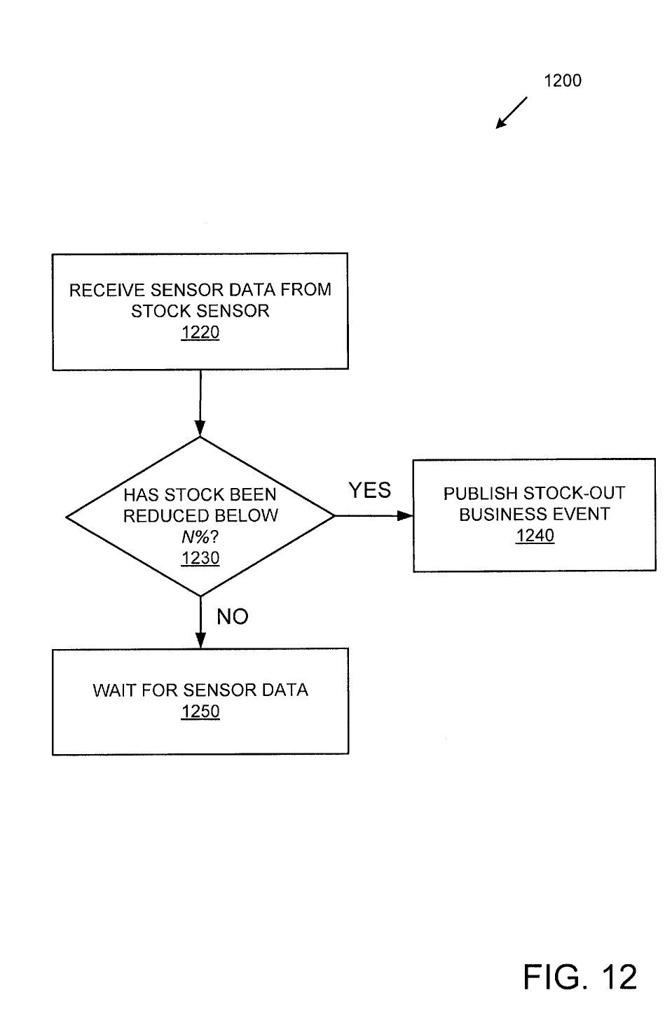

FIG. 12 is a flowchart of an exemplary method 1200 of processing sensor data by an application node to generate an out-of-stock event. For example, method 1200 can be performed by a dynamic shelf such as a product display unit (e.g., comprising one or more shelving units) that can detect product availability such as by using RFID readers and RFID tags.

At 1220, sensor data is received by an application node from a sensor that senses stock of a product. For example, the sensor can sense the number of products sitting on a shelf or the number of products that have been removed from a shelf or display. The stock sensor, the application node, or both can be part of a sensor network or an in-store network.

At 1230, it is decided whether stock has been reduced below a predetermined threshold (e.g., n percent).

After it has been decided that the stock has been reduced below the predetermined threshold, at 1240, a stock-out business event is published.

If it is decided that the stock has not been reduced below the predetermined threshold, at 1250, the application waits for further sensor data.

### Example 36

### Exemplary Delivered Content

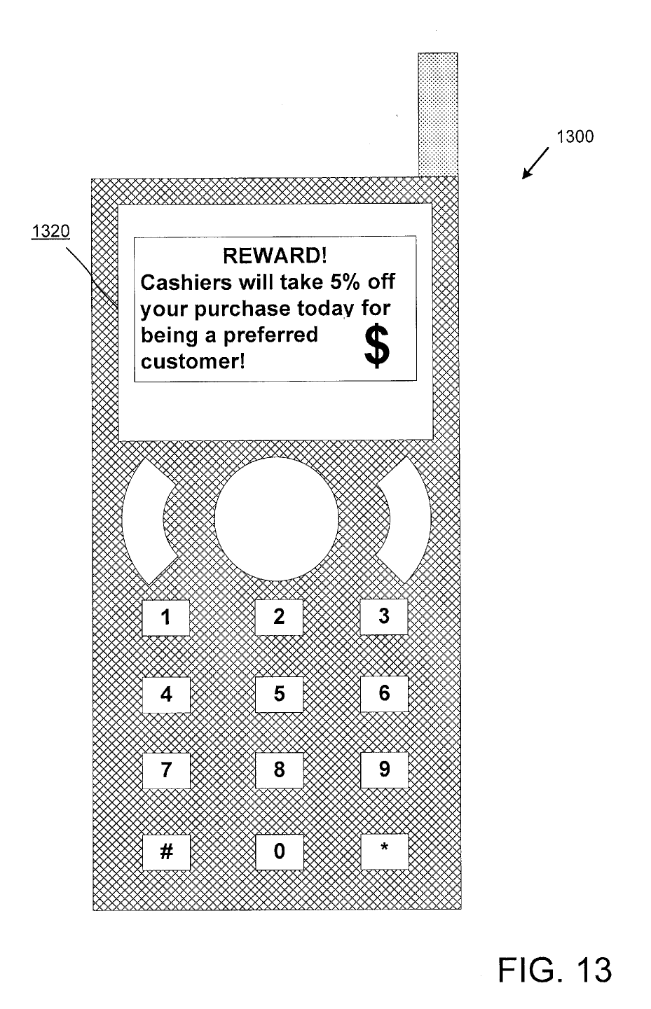

FIG. 13 is an illustration of exemplary content delivery to a cell phone 1300. In the example, the cell phone 1300 is configured to display delivered content for a user (e.g., a shopper) of the cell phone in the display 1320 of the cell phone. The content includes an in-store offer (e.g., a reward) for the shopper that can be redeemed at check-out. The reward indicates that a shopper will receive a discount on the shopper's purchases during the current shopping trip.

Such an offer can motivate the shopper to purchase additional items and can be provided responsive to determining that certain conditions have been met (e.g., as indicated by the shopper context for the shopper).

In other implementations, the content illustrated in the display 1320, or similar content, can be delivered to any other electronic device associated with the shopper.

### Example 37

### Exemplary Delivered Alert

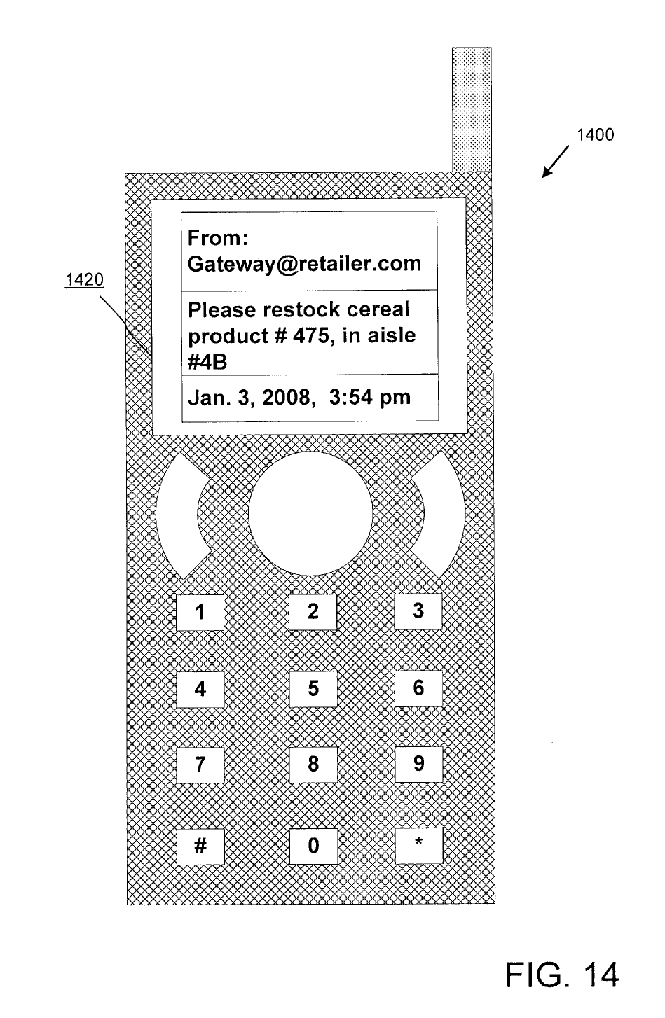

FIG. 14 is an illustration of exemplary content delivery to a cell phone 1400. In the example, the cell phone 1400 is configured to display delivered content for a user of the cell phone in the display 1420 of the cell phone. The content includes an alert in the form of an SMS message. The message indicates that a product stock needs to be replenished (e.g., it is out of stock or low stock). In this example, the user is typically an employee of the store such as a manager or a stocker.

In some implementations, the content illustrated in the display 1420, or similar content, can be delivered to any other electronic device accessible to a store employee (e.g., a computer).

### Example 38

### Exemplary Implementation in a Store

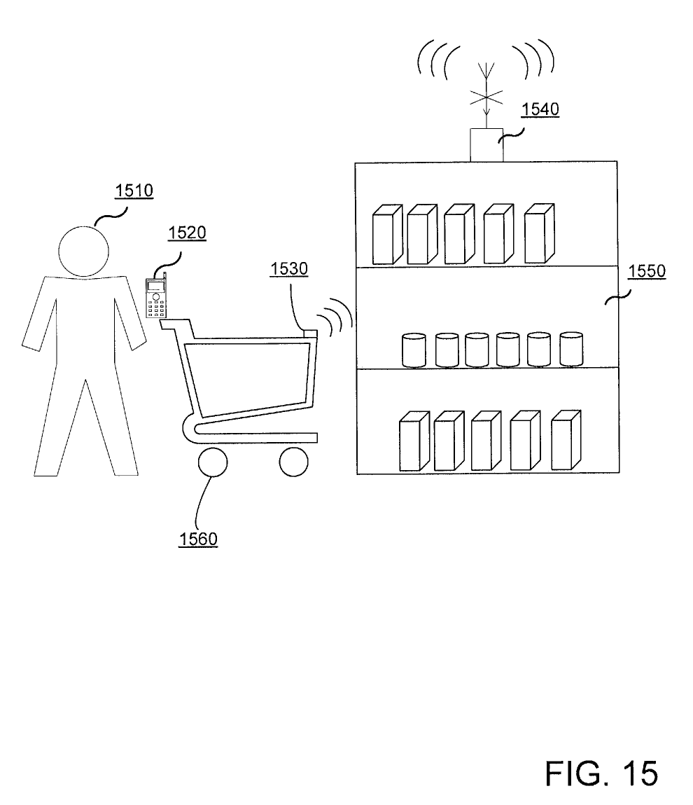

FIG. 15 is an illustration of an exemplary implementation of shopper context awareness in a store. In the illustration, a shopper 1510 pushes a shopping cart 1560 throughout the store during a shopping trip. The shopper 1510 carries with him/her a personal cell phone 1520, and the shopping cart 1560 includes a transponder 1530. As the shopper 1510 moves through the store, the transponder 1530 transmits signals, which can be received by sensors such as sensor 1540 distributed throughout the store.

In this implementation, the sensor 1540 receives the signals transmitted by the transponder 1530 and broadcasts location information to an in-store network. In this manner, the in-store network is able to sense or develop awareness of the location of the shopper near to products 1550.

### Example 39

### Exemplary Scenario

In an exemplary implementation of a sensor network-based context-aware content delivery system, content is delivered to a shopper in a store based on the shopper's movement and activities within the store. The store contains a system of application, sensor, and other nodes for developing shopper context awareness and processing of related business events.

In the example, the shopper enters the store and obtains a shopping cart. The shopper logs in to the in-store network, and a business event is generated. For example, the shopper can key in a shopping cart ID into an application on a cell phone which generates a log-in business event that is published to the network. The shopper can likewise generate a log-in business event by tapping or swiping a shopping assistant mounted to the shopping cart with an ID or loyalty card.

The log-in business event can associate a shopping cart ID with a shopper ID number. For example, the event can associate shopper 205 with a shopping cart fixed with RFID tag #6473. An application node A₂₁ can receive the event and then build and store a shopper context. Application node A₂₁ can also publish the context to the network.

As the shopper moves through the store, sensors distributed in the store sense the movement of the shopping cart. For example, a sensor node S₄ can receive a signal transmitted by the RFID tag on the cart. An application node A₇ can be subscribed to sensor data and can receive sensor data from sensor node S₄. Application node A₇ can determine the location of the tag based on a stored location of sensor node S₄ and optionally based on sensor data received from other sensor nodes. Application node A₇ can then generate and publish a location-type business event indicating that tag #6473 is currently located in the cereal aisle, for example. Application node A₂, can receive the location-type event published by A₇ and update the shopper context.

An application node A₈ can be subscribed to location-type business events and can receive the business event indicating that shopper 205 is currently located in the cereal aisle. Application node A₈ can also be configured to receive location-type events over an extended period of time and to generate shopping routes. For example, application node A₈ can generate a list of location-type events for shopper 205 over time and reconstruct a route through the store. When a location-type business event is received that the cart has returned to the front of the store or is in the parking area, for example, application node A₈ can determine that the route is complete. Application node A₈ can then publish the route information to the network as a route business event indicating that shopper 205 traced a particular shopping route on a specified date and over a specified timeframe. Application node A₂₁ can receive the route business event and update the shopper context.

An application node A₉ can subscribe to location-type business events and can receive the business event that tag #6473 associated with shopper 205 is currently located in the cereal aisle. Application node Ag may then transmit a promotion or coupon for a cereal product to an application node associated with shopper 205 such as a cell phone or a shopping assistant fixed to the shopping cart.

### Example 40

### Exemplary Scenario

In an exemplary implementation of a sensor network-based context-aware content delivery system, content is delivered to a shopper in a store based on the shopper's movement and activities within the store.

In the example, the shopper's shopping cart is configured to provide monitoring of the product choices made by the shopper. For example, the shopping cart can be capable of providing a checkout process and generating purchase business events. The shopping cart can include a barcode scanner paired to the shopper cell phone or to a shopping assistant such as through Bluetooth or other wired or wireless protocols. A purchase business event is generated when the barcode of a product is scanned.

In other examples, products can include transponders and a business event can be generated when a sensor node fixed to the shopping cart senses that the product has been placed in the cart. For example, the shopper cell phone can generate a business event that indicates that shopper 205 placed a box of Sugar Snaps breakfast cereal in the shopper's shopping cart.

An application node A₁₀ can be subscribed to purchase business events and receive the business event that shopper 205 placed a box of Sugar Snaps breakfast cereal in the shopper's shopping cart. Application node A₁₀ can then generate a content-type business event which is transmitted to an application node at the shopping cart such as the shopper's cell phone. For example, application node A₁₀ can transmit a virtual coupon for a competing brand of cereal (e.g., based on a stored relationship with the Sugar Snaps cereal).

In other examples, an application node can transmit a reminder to shopper 205 that they may want to buy milk since they plan to purchase cereal.

In other examples, an application node can transmit a reward (such as a promotion, a virtual coupon, or a discount) to shopper 205 because Sugar Snaps have a high profit margin for the retailer.

### Example 41

### Exemplary Scenario

In an exemplary implementation of a sensor network-based context-aware content delivery system, shopping business events are aggregated by a gateway node and stored for additional analysis. For example, purchase business events and route business events can be analyzed offline to generate correlation statistics for purchases along a particular route. Such analysis can be useful for decisions regarding product placement. In other examples, coupon business events and purchase business events can be analyzed offline to determine effectiveness of coupon distribution.

### Example 42

### Exemplary Scenario

In an exemplary implementation of a sensor network-based context-aware content delivery system, content is delivered based on the movements and activities of numerous shoppers within a store. A mesh network of applications and sensors for developing shopper context awareness is distributed in the store.

In the example, the locations of numerous shoppers in the store are sensed via the mesh network. An application node uses the known locations of the shoppers to determine whether shoppers are concentrated in certain sections of the store and, based on the processing, generates shopping business events.

In some examples, it can be determined by one or more applications on the network that a group of shoppers are concentrated in a section of the store near to the check-out area indicating that the group of shoppers may be checking-out soon. Based on the determination, a notice is sent to an employee of the store or to a manager that more assistance is needed in the check-out area (e.g., additional check-out lanes need to be opened).

In another example, shopper traffic through the store during certain times of the day or during certain days of the week can be determined by one or more applications on the network. Employee work schedule decisions can then be based on this information.

### Example 43

### Exemplary Scenario

In an exemplary implementation of a sensor network-based context-aware content delivery system, content is delivered to a shopper in a store based on the shopper's movement and activities within the store.

In the example, the shopper lingers in an area of the store or in front of a display while making a product choice. This type of shopper activity is sensed and responded to by a network of sensor and application nodes. For example, the network can sense that a shopper is currently located at a candy bar display and can generate a business event that indicates the length of time that the shopper has been located at the candy bar display.

An application node can generate a content-type business event when the length of time that the shopper is in front of the display exceeds a predetermined idle time. For example, when the shopper has been located in front of the candy bar display for at least n seconds or minutes (e.g., 60 seconds), a content-type event such as a candy bar virtual coupon can be delivered to the shopper to entice the shopper to buy a candy bar from the display.

Whether or not the shopper decides to buy the displayed product can be recorded or stored in a database for real-time or offline analytics to determine the effectiveness of such an approach. In this manner, analytics may be used to fine-tune a time threshold and therefore content delivery.

### Example 44

### Exemplary Scenario

In an exemplary implementation of a sensor network-based context-aware content delivery system, dynamic shelves can be included in the network. For example, a dynamic shelf can be an application node, a sensor node, or both configured to monitor stock on a particular shelf.

For example, the dynamic shelf can include a sensor that monitors weight of products on the shelf and communicates such weight information to an application node. When the application node determines that the weight is below a predetermined threshold, the application node can generate an out-of-stock business event. The out-of-stock business event can be published to the network.

In other examples, the dynamic shelf can be a display unit that can detect product availability using RFID readers and RFID tags. When an application in communication with the dynamic shelf determined that stock has been reduced below a pre-determined threshold, an out-of-stock business event can be published to the network.

An application node or gateway node can receive the out-of-stock business event and generate an alert such as a text (e.g. SMS) message to be sent to an employee in charge of stocking shelves.

### Example 45

### Exemplary Computing Environment

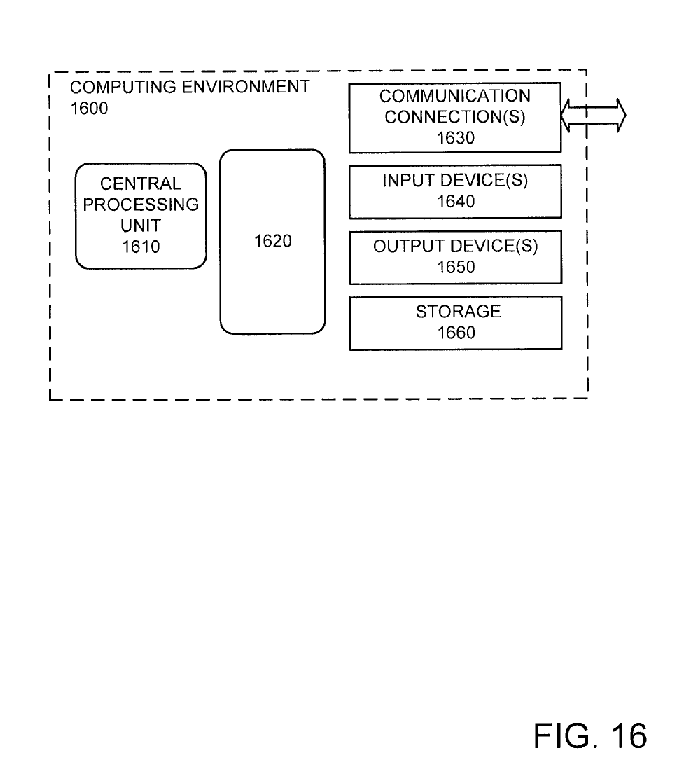

FIG. 16 illustrates a generalized example of a suitable computing environment 1600 in which the described techniques can be implemented. For example, computing environment 1600 is an exemplary computing environment for implementing a sensor network-based context-aware content delivery system as described herein. Computing and processing devices (e.g., physical machines) described herein can be configured as shown in the environment 1600. The computing environment 1600 is not intended to suggest any limitation as to scope of use or functionality, as the technologies can be implemented in diverse general-purpose or special-purpose computing environments. Mobile computing devices can similarly be considered a computing environment and can include computer-readable media. A mainframe environment can be different from that shown, but can also implement any of the technologies described herein and can also have computer-readable media, one or more processors, and the like.

With reference to FIG. 16, the computing environment 1600 includes at least one processing unit 1610 and memory 1620. The processing unit 1610 executes computer-executable instructions and can be a real or a virtual processor. In a multi-processing system, multiple processing units execute computer-executable instructions to increase processing power. The memory 1620 can be volatile memory (e.g., registers, cache, RAM), non-volatile memory (e.g., ROM, EEPROM, flash memory, etc.), or some combination of the two. The memory 1620 can store software implementing any of the technologies described herein.

A computing environment can have additional features. For example, the computing environment 1600 can include storage 1660, one or more input devices 1640, one or more output devices 1650, and one or more communication connections 1630. An interconnection mechanism (not shown) such as a bus, controller, or network interconnects the components of the computing environment 1600. Typically, operating system software (not shown) provides an operating environment for other software executing in the computing environment 1600, and coordinates activities of the components of the computing environment 1600.

The storage 1660 can be removable or non-removable, and includes magnetic disks, magnetic tapes or cassettes, CD-ROMs, DVDs, or any other computer-readable media which can be used to store information and which can be accessed within the computing environment 1600. The storage 1660 can store software containing computer-executable instructions for any of the technologies described herein.

The input device(s) 1640 can be a touch input device such as a keyboard, keypad, touch screen, mouse, pen, or trackball, a voice input device, a scanning device, or another device that provides input to the computing environment 1600. For audio, the input device(s) 1640 can be a sound card or similar device that accepts audio input in analog or digital form, or a CD-ROM reader that provides audio samples to the computing environment. The output device(s) 1650 can be a display, printer, speaker, CD-writer, or another device that provides output from the computing environment 1600.

The communication connection(s) 1630 enable communication over a communication medium to another computing entity. The communication medium conveys information such as computer-executable instructions, audio/video or other media information, or other data in a modulated data signal. Communication media can embody computer-readable instructions, data structures, program modules or other data in a modulated data signal such as a carrier wave or other transport mechanism and includes any information delivery media. A modulated data signal is a signal that has one or more of its characteristics set or changed in such a manner as to encode information in the signal. By way of example, and not limitation, communication media include wired such as a wired network or direct-wired connection and wireless media such as acoustic, RF, infrared and other wireless media. Communication media can be implemented with an electrical, optical, RF, infrared, acoustic, or other carrier. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules can be combined or split between program modules as desired in various embodiments. Computer-executable instructions for program modules can be executed within a local or distributed computing environment.

### Example 46

### Exemplary Advantages

Retailers and CPG firms in the United States reportedly spend about $113 billion annually on doing things that drive customer traffic into a store (e.g., generating ads to encourage customers to go shopping). It is also estimated that most buying decisions by a shopper are made in-store during the act of shopping. Even if ads do indeed get customers into the store, the presence of a shopper in the store is typically not recognized until about 35-40 minutes on average after the time of shopper entry into the store. Since this recognition typically only happens at the checkout counter, it is generally too late to have any useful interactions with the shopper such as cross-sell/up-sell, customized promos, brand switching, and the like.

Retailers and CPG firms alike have made significant investments in analytical tools for market basket analysis, item affinity analysis, customer segmentation, and the like. The insights drawn from such analysis can be the basis for decisions on pricing, promotions, product placement and planograms among others. However, this whole process is typically an off-line activity and results in a “one-thing-fits-all” model, which can contribute to ineffective promos (consumers are smart enough to cherry pick products on promotion), reduced sales/foot fall etc.

Through use of a sensor network-based context-aware content delivery system, shopper presence and activity can be recognized and monitored during a shopping trip and content can be delivered to the shopper based on this shopper awareness. Furthermore, a sensor network-based context-aware content delivery system can provide content delivery to users based upon their preferences and product choices. The retail industry can leverage a sensor network-based context-aware content delivery system in the implementation of existing consumer focused content intensive resources for product launches, campaigns and promotions using delivery channels like in-store media (displays, kiosks, cart mounted displays etc), coupons, print media among others.

In addition, retailers can also reward profitable customers in their profitable transactions. For example, enticing a customer who has picked several high margin items in a given visit with a special personalized discount (created on the fly based on current context) on a complementary item to increase top line.

A sensor network-based context-aware content delivery system senses physical world events and uses them to make real-time decisions on the choice of content, choice of delivery media and the timing of the delivery. The system also facilitates correlation measurements between delivered content and results as a means to measure effectiveness. The system is easily integrated into a business model for content monetization wherein pricing is based on effectiveness of content delivery.

Through use of a shopper's cell phone as a platform to deliver context-aware content, retailers can also reduce the need for expensive in-store electronic media displays.

In general, a sensor network-based context-aware content delivery system provides an easily customizable, flexible, and dynamic system for use by retailers and CPG companies among others. A sensor network-based context-aware content delivery system can be easily integrated with other systems and applications while recording a diversity of information for data mining by retailers or product/brand representatives.

### Exemplary Applications

Any of the examples herein can be applied in the area of content delivery to shoppers in a store. Examples described herein can also be applied in other areas where context-aware content delivery is desired. In addition, the technologies described herein can be used in combination with other such systems.

### Methods in Computer-Readable Media

Any of the methods described herein can be implemented by computer-executable instructions in one or more computer-readable media (e.g., computer-readable storage media, other tangible media, or the like). Such computer-executable instructions can cause a computer to perform the described method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of these claims.

I claim:

1. A computer-implemented method comprising:
receiving low-level location information from a plurality of sensors operable to detect the presence and identity of a plurality of transponders located on a plurality of shopping carts;
based on the low-level location information, publishing via an in-store network, shopping business events indicative of in-store locations for respective shopping carts of the plurality of shopping carts;
based on an in-store location of a respective shopping cart, constructing a shopper context for at least one shopper, wherein the shopper context comprises a shopping history for the at least one shopper;
responsive to analysis of the shopper context, while the at least one shopper is shopping, choosing content comprising an in-store offer to be presented to the at least one shopper; and
while the at least one shopper is shopping, delivering the content comprising the in-store offer to an electronic device associated with the at least one shopper.

2. The method of claim 1 further comprising:
responsive to receipt of the in-store location of the respective shopping cart, building a shopper path comprising a plurality of in-store locations for the respective shopping cart;
updating the shopper context for the at least one shopper to include the shopper path; and
wherein choosing the content is based at least on the shopper path.

3. The method of claim 1 further comprising:
responsive to receipt of the in-store location of the respective shopping cart and determination that the respective shopping cart has not changed locations after a threshold time period, publishing a shopping business event indicative of an idle shopper and a location at which the shopper has been idle; and
based on receipt of the shopping business event indicative of an idle shopper and the location at which the shopper has been idle, choosing the content comprising the in-store offer.

4. The method of claim 3 further comprising:
identifying a product proximate the location at which the shopper has been idle;
wherein the choosing is based at least on having identified the product proximate the location and the in-store offer promotes the product proximate the location.

5. The method of claim 1 further comprising:
publishing a shopping business event indicative of a shopper product choice; and
based on receipt of the shopping business event indicative of the shopper product choice and responsive to analysis of the shopper context, choosing the content comprising the in-store offer.

6. The method of claim 1 further comprising:
storing the shopper context, published shopping business events, and shopper response to the content; and
analyzing effectiveness of the content based at least on the shopper response.

7. The method of claim 1 further comprising:
receiving an out-of-stock shopping business event; and
responsive to receiving the out-of-stock shopping business event, sending a text message to a store employee for re-stocking a product.

8. The method of claim 1 further comprising:
receiving a shopping business event indicative of a purchase made through a perpetual checkout system, wherein the perpetual checkout system is enabled by an application on a cell phone configured to communicate with a barcode scanner; and
wherein the choosing is based at least on having received the shopping business event indicative of the purchase.

9. The method of claim 1 wherein the electronic device associated with the at least one shopper is a personal cell phone of the at least one shopper.

10. A computer-implemented method comprising:
receiving low-level information indicative of shopper locations and of shopper activities in a store, the low-level information being received from a mesh network of sensors comprising a plurality of radio frequency readers operable to detect a plurality of radio frequency identification tags, wherein at least a portion of the plurality of radio frequency identification tags are located on a plurality of shopper locator devices in the store and wherein at least one of the plurality of shopper locator devices is associated with a shopper;
based on the received low-level information, generating location-type shopping business events indicative of the shopper locations and other shopping business events indicative of the shopper activities;
publishing via an in-store network, the location-type shopping business events and the other shopping business events;
based at least partially on the published location-type shopping business events and the published other shopping business events, constructing a shopper context for the shopper wherein the shopper context comprises an association between the at least one of the plurality of shopper locator devices and the shopper;
receiving and processing at least one of the other shopping business events based on the shopper context;
responsive to the processing, choosing content comprising an in-store offer to be presented to the shopper; and
while the shopper is in the store, delivering the content comprising the in-store offer via a shopper cell phone.

11. One or more computer-readable media having computer executable instructions for performing a method comprising:
building a shopper context,
wherein the building comprises:
receiving high-level location information for a shopper in a store based on data generated by sensors and on an association between the one or more of the transponders and the shopper, wherein the sensors are configured to sense locations of one or more transponders located in the store and to communicate with an in-store network; and
associating the high-level location information for the shopper with a shopper identifier and a shopping history;
subscribing to a business event indicative of a shopper activity;
choosing context relevant content to be delivered to the shopper while the shopper is in the store responsive to analysis of the business event indicative of the shopper activity, the analysis being based on the shopper context; and
choosing a method of delivery of the context relevant content based on the context relevant content and the analysis.

12. The method of claim 11, wherein:
the business event indicative of the shopper activity indicates that the shopper has placed a product in a shopping cart, and
the context relevant content comprises an in-store offer for an other product, the in-store offer intended to encourage the shopper to purchase the other product.

13. The method of claim 12, further comprising:
generating a business event indicative of a purchase by the shopper; and
associating the business event indicative of the purchase with the context relevant content.

14. The method of claim 11, wherein:
the business event indicative of the shopper activity indicates that the shopper has decided to purchase a product,
the choosing of the context relevant content is based on a profit margin of the product, and
the context relevant content comprises an in-store offer.

15. The method of claim 11, wherein:
the business event indicative of the shopper activity indicates that the shopper has made a product choice, and
the context relevant content comprises a reminder to purchase an other product based on the product choice.

16. The method of claim 11, wherein:
the shopping history comprises shopper specific information comprising shopper product preferences,
the choosing of context relevant content is based at least on the shopper product preferences, and
the context relevant content comprises an in-store offer.

17. The method of claim 11, further comprising:
delivering the context relevant content to an application on a cell phone associated with the shopper while the shopper is in the store.

18. A system comprising:
a plurality of sensors distributed in a retail store and configured to receive data transmitted from one or more transponders on shopping carts and to generate sensor data indicative of locations of the shopping carts;
a plurality of application nodes configured in a mesh network, wherein one or more of the plurality of application nodes is configured to receive the sensor data and to generate location-type business events based on the received sensor data and one or more others of the plurality of application nodes is configured to process the location-type business events to chose an in-store offer to be delivered to shoppers associated with the shopping carts.

19. The system of claim 18, wherein at least one of the plurality of application nodes is configured to build shopper contexts based on the sensor data.

20. The system of claim 18, wherein the application nodes and the sensors communicate based on mesh networking protocols.

21. The system of claim 18, wherein at least one of the plurality of application nodes is configured to publish business events indicative of shopper activities in the store.

22. The system of claim 18, wherein:
at least one of the plurality of sensors is configured to monitor product choices made by the shopper, and
at least one of the plurality of application nodes is configured to subscribe to business events indicating the product choices and to chose content to be delivered to the shopper based on the business events.

23. The system of claim 18, wherein:
at least one of the plurality of sensors is configured to monitor a quantity of a product in the retail store, and
at least one of the plurality of application nodes is configured to subscribe to business events indicative of a stock of the product and to chose an alert to be delivered to a individual based on the stock.

24. The system of claim 18, further comprising:
a database comprising stored data indicative of shopper contexts, published events, and shopper responses to delivered content; and
a processor configured to analyze the stored data to evaluate effectiveness of the delivered content.

25. A system comprising:
means for receiving low-level location information from a plurality of sensors operable to detect the presence and identity of a plurality of transponder means located on a plurality of shopping carts;
means for publishing via an in-store network, business events indicative of in-store locations for respective shopping carts of the plurality of shopping carts based on the low-level location information;
means for constructing a shopper context for at least one shopper, wherein the shopper context comprises a shopping history for the shopper and is based on an in-store location of a respective shopping cart;
means for choosing content comprising an in-store offer to be presented to the shopper responsive to analysis of the shopper context; and
means for delivering the content comprising the in-store offer to an electronic device associated with the shopper while the shopper is shopping.
